(19) United States
(12) Patent Application Publication
(10) Pub. No.: US 2006/0253422 A1
(43) Pub. Date: Nov. 9, 2006

(54) Efficient computation of multiple group by queries

(75) Inventors: Vivek R. Narasayya, Redmond, WA (US); Zhimin Chen, Redmond, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: Microsoft Corporation, Redmond, WA (US)

(21) Appl. No.: 11/124,516

(22) Filed: May 6, 2005

(51) Int. Cl. G06F 17/30

(52) U.S. Cl. 707/2

(57) ABSTRACT

Systems and methodologies for computation of multiple group by queries via an optimizer that examines the space of plans in a systematic and cost based manner. The optimizer includes a merging component to merge pairs of sub plans to facilitate a plan choice with a lowest cost. The merging component can take as input two sub plans (e.g., sub plan P₁ with root node V₁ and sub plan P₂ with root node V₂, wherein each sub plan is a sub-tree of a logical plan whose root node is directly pointed to a Relation “R”), to return a set of sub-plans as out put with a root node V₁∪V₂ that is the smallest relation from which both V₁ and V₂ can be computed.

### TECHNICAL FIELD

The subject invention relates generally to executing Group By queries, and more particularly to efficient computation techniques for determining a plan choice that has the lowest cost among a plurality of plans.

### BACKGROUND OF THE INVENTION

Increasing advances in computer technology (e.g., microprocessor speed, memory capacity, data transfer bandwidth, software functionality, and the like) have generally contributed to enhanced computer application in various industries. Ever more powerful server systems, which are often configured as an array of servers, are commonly provided to service requests originating from external sources such as the World Wide Web, for example.

As the amount of available electronic data grows, it becomes more important to store such data in a manageable manner that facilitates user friendly and quick data searches and retrieval. A common approach is to store electronic data in one or more databases. Today, a Data Base Management System (DBMS) can typically manage any form of data including text, images, sound and video.

In general, a typical database can be referred to as an organized collection of information with data structured such that a computer program can quickly search and select desired pieces of data, for example. Commonly, data within a database is organized via one or more tables. Such tables are arranged as a set of rows (or records). Each row consists of a set of columns (or fields). Records are commonly indexed as rows within a table and the record fields are typically indexed as columns, such that a row/column pair of indices can reference a particular datum within a table. For example, a row may store a complete data record relating to a sales transaction, a person, or a project. Likewise, columns of the table can define discrete portions of the rows that have the same general data format, wherein the columns can define fields of the records.

Often data analysts need to understand the quality of data in the database/warehouse. For example, decision support analysis on data warehouses influences important business decisions, and hence the accuracy of such analysis is crucial. Therefore, understanding the quality of data is an important requirement for a data analyst. For example, if the number of distinct values in the State column of a relation describing customers within the United States is more than 50, such could indicate a potential problem with data quality. Other examples include the percentage of missing (NULL) values in a column, the maximum and minimum values etc.

Typically, queries for such tables can be constructed in accordance to a standard query language (e.g., structured query language (SQL)), to access content of a table in the database. Likewise, data can be input (e.g., imported) into the table via an external source. Such is often done by issuing many Group By queries on the sets of columns of interest. Since the volume of data in these warehouses can be large, and tables in a data warehouse often contain many columns, this analysis typically requires executing a large number of Group By queries, which can be expensive. A naïve approach is to execute a different Group By query for each set of columns.

At the same time GROUPING SETS is not optimized for scenarios where many column sets with little overlap among them are requested, which represent a common data analysis scenario. Often the search space, (e.g., the space of queries that are not required, but results of which could speed up execution of the required queries), is very large. For example, for a relation with 30 columns, if one desires to compute all single column Group By queries, the entire space of relevant Group-By queries to consider will be 2³⁰. Such search space is often neglected, and not considered when executing group by queries.

Therefore, there is a need to overcome the aforementioned exemplary deficiencies associated with conventional systems and devices.

### SUMMARY OF THE INVENTION

The following presents a simplified summary of the invention in order to provide a basic understanding of one or more aspects of the invention. This summary is not an extensive overview of the invention. It is intended to neither identify key or critical elements of the invention, nor to delineate the scope of the subject invention. Rather, the sole purpose of this summary is to present some concepts of the invention in a simplified form as a prelude to the more detailed description that is presented hereinafter.

The subject invention provides for systems and methods of optimizing grouping set queries via an optimizer that examines the space of plans in a systematic and cost based manner, and accepts as input a logical plan for a grouping set query to produce an equivalent logical plan of the grouping set query, wherein the equivalent logical plan and/or grouping set query can turn out to enjoy a lower cost than the inputted grouping set query. The optimizer includes a merging component to merge pairs of sub plans to facilitate a plan choice with a lowest cost. The merging component can take as input two sub plans (e.g., sub plan P₁ with root node V₁ and sub plan P₂ with root node V₂, wherein each sub plan is a sub-tree of a logical plan whose root node is directly pointed to a Relation “R”), to return a set of sub-plans as out put with a root node V₁∪V₂, which is the smallest relation from which both V₁ and V₂ can be computed. Moreover, from all the plans generated thru the merging component, the lowest cost plan and/or the plan with the least execution time can be chosen, and other pairs discarded. Accordingly, the invention exploits opportunities available by examining the space and alternative logical plans that exist for computing a set of group by queries.

According to a methodology of the subject invention, initially a logical plan for a given set S of Group by Queries for a Relation R can be initiated on a naïve plan that is computed directly from Relation R, and a cost of such plan (e.g., the expense and/or time associated with execution of a query) can be designated. Subsequently, a loop can be created, wherein for each iteration of such loop the available plans are paired together and merged to create new plans. Upon completion of each iteration a plan with the lowest cost can be maintained and the remainder of the plans discarded. The process is then repeated on the maintained plans. For example, initially the queries A, B, C, D exist as individual queries that are computed from a base relation R. In a first iteration, merger for A&B, A&C, A&D, B&C, B&D, and C&D is considered. Assuming that A&B yield the lowest cost, a new sub plan with node AB can be created and computed from R, and individually A and B will be computed from such node AB. Accordingly, at the end of the first iteration two of the existing plans A, B are merged into one, and C and D are computed from the base relation R. In the second iteration A and B are discarded and a plan rooted in AB is maintained (e.g., greedily frozen) and the process is reiterated by considering merging the sub plan rooted at AB with C, the sub plan rooted at AB with D, and also considering merging C and D. Assuming that merging C and D provides the lowest cost and the highest benefit, a new sub plan with node CD can be created and computed from R. Nodes C and D can then be individually computed from the node CD. As such, at the end of the second iteration two sub plans remain, wherein one sub plan is rooted in AB and another rooted in CD. Likewise, a merger of AB and CD to create a node ABCD can be considered if such merger can lower the associated cost. In general, to be able to continue with the iterations, at least one merging that reduces the costs should be possible.

In a further aspect of the subject invention, the lattice that corresponds to data structure of the grouping set query can be built bottom-up. Thus, from a sub-part of the lattice a larger set can be created, and it typically is not a pre-requisite to initially or pro-actively form or materialize the entire lattice associated with the grouping set query. Each node in the lattice represents a group by query. Put differently, the equivalent grouping set query can be generated by exploring possible group by queries in a bottom up manner, without initially materializing an entire lattice associated therewith. As such, the subject invention provides a scalable solution that can efficiently employ memory resources of the system. Moreover, additional set of group by nodes that are not specified in a logical plan for the grouping sets query (e.g., an inputted and/or original logical plan) can be introduced.

According to yet another aspect, additional transformation roots can be introduced into an existing query optimizer that is integrated with the subject invention. For example, when a query is more than a simple query and includes filter predicates, initially a grouping set operation can be performed, followed by applying the filters on top, to obtain a more efficient plan. Moreover, similar to selections, for a reference join a grouping set computation can be pushed below the join, via a transformation rule. The subject invention can provide for different re-writings of the same query, and can supply a suitable fit with existing query optimizers.

In a further aspect of the subject invention, an amount of storage for an intermediate table can be reduced by executing a selected plan in a particular order. Accordingly, for each node a determination can be made as to whether breadth-first (BF) or a depth-first (DF) traversal is preferable.

In accordance with yet another aspect of the subject invention, a cost model for determining a cost for the space of plans can be based on a query optimizer of an associated database. For example, such cost model can consider the number of distinct values in a particular row or a particular column, which are already modeled by the query optimizer. Accordingly, a possibility of being out of sync with the optimizer can be mitigated. It is to be appreciated that when a query optimizer is to be invoked, tables need to be created for nodes that are not materialized, for example in a form of a dummy table that represents a particular node, as the query optimizer is concerned with statistics and not the data itself. Put differently, a table that does not actually exist can be simulated syntactically.

To the accomplishment of the foregoing and related ends, the invention, then, comprises the features hereinafter fully described. The following description and the annexed drawings set forth in detail certain illustrative aspects of the invention. However, these aspects are indicative of but a few of the various ways in which the principles of the invention may be employed. Other aspects, advantages and novel features of the invention will become apparent from the following detailed description of the invention when considered in conjunction with the drawings.

### BRIEF DESCRIPTION OF THE DRAWINGS

FIG. 1 illustrates a schematic block diagram of an optimizer with a merging component that can supply an equivalent grouping set query in accordance with an aspect of the subject invention.

FIG. 2 illustrates a schematic diagram of an optimizer component with a cost comparator in accordance with an aspect of the subject invention.

FIG. 3 illustrates an exemplary option for merger of two sub-plans [symbol] ₁ and [symbol] ₂ in accordance with an aspect of the subject invention.

FIGS. 4a-4d illustrate various exemplary results for merger of two sub-plans [symbol] ₁ and [symbol] ₂, of FIG. 3.

FIG. 5 illustrates two exemplary equivalent logical expressions for computing GROUPING SETS {(A),(B)}, in accordance with an aspect of the subject invention.

FIG. 6 illustrates a transformation in accordance with an aspect of the subject invention.

FIG. 7 illustrates an exemplary execution order in accordance with the subject invention.

FIG. 8 illustrates a client-server that can implement various aspects of the invention.

FIG. 9 illustrates a brief, general description of a suitable computing environment is illustrated wherein the various aspects of the subject invention can be implemented.

### DETAILED DESCRIPTION OF THE INVENTION

The subject invention is now described with reference to the drawings, wherein like reference numerals are used to refer to like elements throughout. In the following description, for purposes of explanation, numerous specific details are set forth in order to provide a thorough understanding of the subject invention. It may be evident, however, that the subject invention may be practiced without these specific details. In other instances, well-known structures and devices are shown in block diagram form in order to facilitate describing the subject invention.

As used in this application, the terms “component,” “handler,” “model,” “system,” and the like are intended to refer to a computer-related entity, either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers. Also, these components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal).

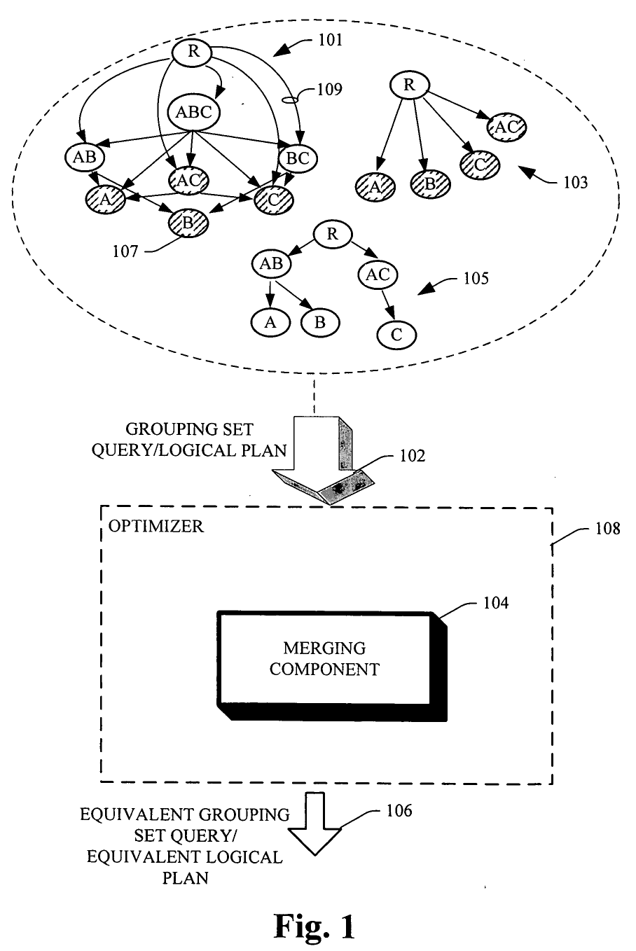

The subject invention provides for systems and methods of optimizing grouping set queries by examining the space of plans in a systematic and cost based manner, wherein a merging component merges pairs of sub plans to facilitate creating an equivalent grouping set query. As such a scalable approach can be provided, wherein a sub-part of the lattice is initially created, and it typically is not a pre-requisite to first materialize the entire lattice associated with the grouping set query. Referring initially to FIG. 1, there is illustrated a schematic block diagram of an optimizer 108 in accordance with an aspect of the subject invention. The optimizer 108 can take as input a grouping set query and/or logical plan 102, and produce an equivalent grouping set query and/or equivalent logical plan 106. The optimizer 108 includes a merging component 104, which can take as input two sub plans, as is described in detail infra, for example sub plan P₁ with root node V₁ and sub plan P₂ with root node V₂, wherein each sub plan is a sub-tree of a logical plan whose root node is directly pointed to a Relation “R” (not shown), to return a set of sub-plans as out put with a root node V₁∪V₂, which is the smallest relation from which both V₁ and V₂ can be computed. Accordingly, the invention exploits opportunities available by examining the space and alternative logical plans that exist for computing a set of group by queries.

In general, assuming a given relation R, and a set S={s₁, s₂, . . . sₙ} of group by queries over R, and designating G=(V, E) as a directed acyclic graph (DAG), which can be defined such that a node in the graph corresponds to a Group By query, and the set of nodes V contains all elements of the power set of s₁∪s₂∪ . . . sₙ, wherein s₁, s₂, . . . sₙ themselves are nodes in the graph. Such nodes in S can be referred to as required nodes, since it is required to produce the results for these nodes. The edge set E can contain a directed edge from node u to v if, u⊃v. A reference to u can be made as the ancestor of v, and v as the descendant of u. In addition, there can be one distinguished node labeled the root node, which represents the relation R itself. Such root node has an outgoing edge to every other node in V (since it is an ancestor of every other node). G can be designated as the Search DAG.

Accordingly, assuming R(A,B,C,D), and S={(A), (B), (C), (A,C)}. The search DAG for the input {(A), (B), (C), (AC)} can be illustrated as 101. A node 107 can indicate a result of a query, and an arrow 109 indicates that a result can be computed from a parent node. In addition, a shaded node (e.g., 107) can indicate a node that is requested by a user.

Designating [symbol] as a logical plan for computing S, e.g., for computing all queries s₁, . . . sₙ, [symbol] is a directed tree over the Search DAG, rooted at R, and including all required nodes. Such tree can also be viewed as a partial order of SQL queries. As such, an edge from node u->v in the tree can signify that v is computed as a Group-By query over the table u. At the same time, if u≠R, (e.g., u is an intermediate node in the tree) then u requires to be materialized as a temporary table before v can be computed from it.

As illustrated in FIG. 1, 103, 105 indicate two different logical plans for the input S={(A), (B), (C), (AC)}. The required nodes are shaded. In logical plan 103, all the required nodes are computed from the root node, e.g., base relation R. In plan 105, (A,B) is computed from R, its results are materialized, and both (A) and (B) are computed from it. Likewise, (A,C) is computed directly from R, its results materialized, and (C) is computed from the results of (A,C). In 105, the sub-trees rooted at (AB) and (AC) can both be considered sub-plans (e.g., a sub-tree of a logical plan whose root node is directly pointed to by R.)

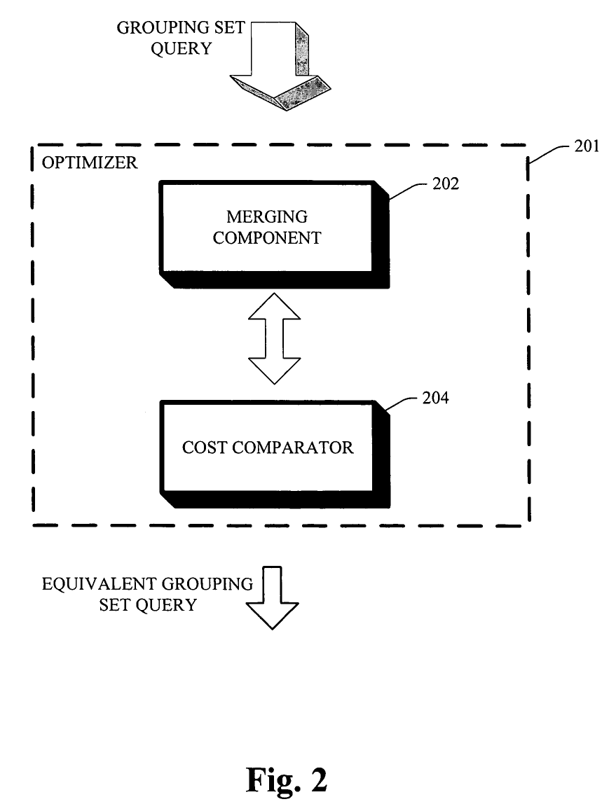

FIG. 2 illustrates a schematic diagram of an optimizer component 201 with a cost comparator, in accordance with an aspect of the subject invention. The optimizer component 201 employs a cost comparator 204 to efficiently compute all Group By queries in S, e.g., find an efficient logical plan for S. It is to be appreciated that the subject invention can employ typically any cost model, and the two cost models described below are mere examples. One exemplary cost model that can be employed by the cost comparator 204 is the Cardinality Cost Model. Such cost model assumes that the cost of an edge from u->v in the Search DAG is the number of rows of the table u, denoted by |u|. Such can provide a simple cost model that captures cost of scanning the relation u, which is often a reasonable indicator of the cost, particularly when there are no (relevant) indexes on the table u. It is to be appreciated that to employ the Cardinality cost model, a cardinality of a Group By query may be estimated.

In another aspect, a cost model for the comparator 204 can be based on a query optimizer. For example, such cost model can consider the number of distinct values in a particular row or a particular column, which are already modeled by a query optimizer. Accordingly, a possibility of being out of sync with the optimizer can be mitigated. It is to be appreciated that when such a query optimizer is to be invoked, tables need to be created for nodes that are not materialized, for example in a form of a dummy table that represents a particular node—as the query optimizer is concerned with statistics and not the data itself. Put differently, a table that does not actually exist can be simulated syntactically.

Accordingly, the query optimizer (not shown) of the DBMS itself, (capable of estimating the cost of an individual query), can be employed as the basis of the cost model. In particular, the Cost ( [symbol] ) can be modeled as the sum of the optimizer estimated cost of each SQL query in [symbol] . Such cost model can capture the effects of the current physical design in the database. For example, if a query can take advantage of an existing index in the database, then such can be automatically reflected in the optimizer estimated cost.

At the same time, cost models employed by a query optimizer in today's database systems are already quite sophisticated, and hence able to take advantage of database statistics (e.g., histograms, distinct value estimates, and the like) for producing accurate estimates for many cases. As explained earlier, to employ such cost model, an ability must typically exist to cost a query, such as u->v when u is not the base relation R, e.g., u does not actually exist as a table in the database. To do so, capabilities of “what-if” analysis APIs in today's commercial query optimizers can be advantageously employed. Such APIs enable a capability to pretend (as far as the query optimizer is concerned) that a table exists, and has a given cardinality and database statistics. Moreover, the cost of materializing a temporary table can also be handled in such model in a straightforward manner. For a query u->v, where v needs to be materialized, the query can be constructed as a SELECT . . . INTO v . . . (or equivalently INSERT INTO v SELECT . . . ), which can also be submitted to the query optimizer for cost estimation.

Given a relation R, and a set of data Group By queries on R denoted by S={s₁, . . . sₙ} the subject invention facilitates finding a logical plan for S having the lowest cost, e.g., can find a logical plan [symbol] that minimizes Cost ( [symbol] ). Such can also be referred as the Group-By Multi-Query Optimization (GB-MQO).

As explained earlier and referring to FIG. 2, the merging component 202 can merge two logical sub-plans [symbol] ₁ and [symbol] ₂ as the basic operation for the optimizer 201 to generate new logical sub-plans as described below. Such operation can be referred to as the SubPlanMerge operator. The SubPlanMerge operator (described in detail infra) has the desirable property that the root node of each new sub-plan output by the operator is the node with minimal cardinality from which the sub-plans [symbol] ₁ and [symbol] ₂ can be computed.

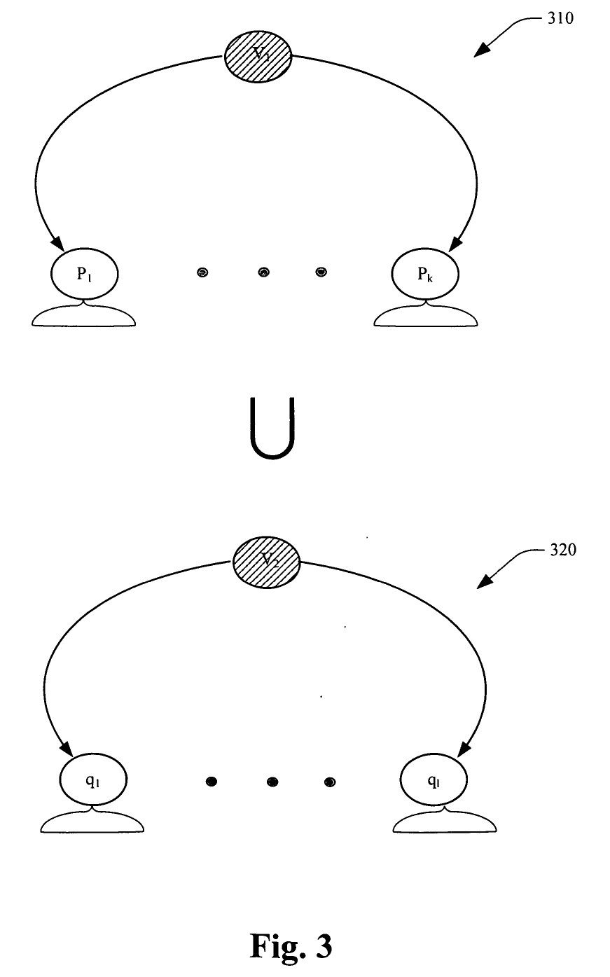

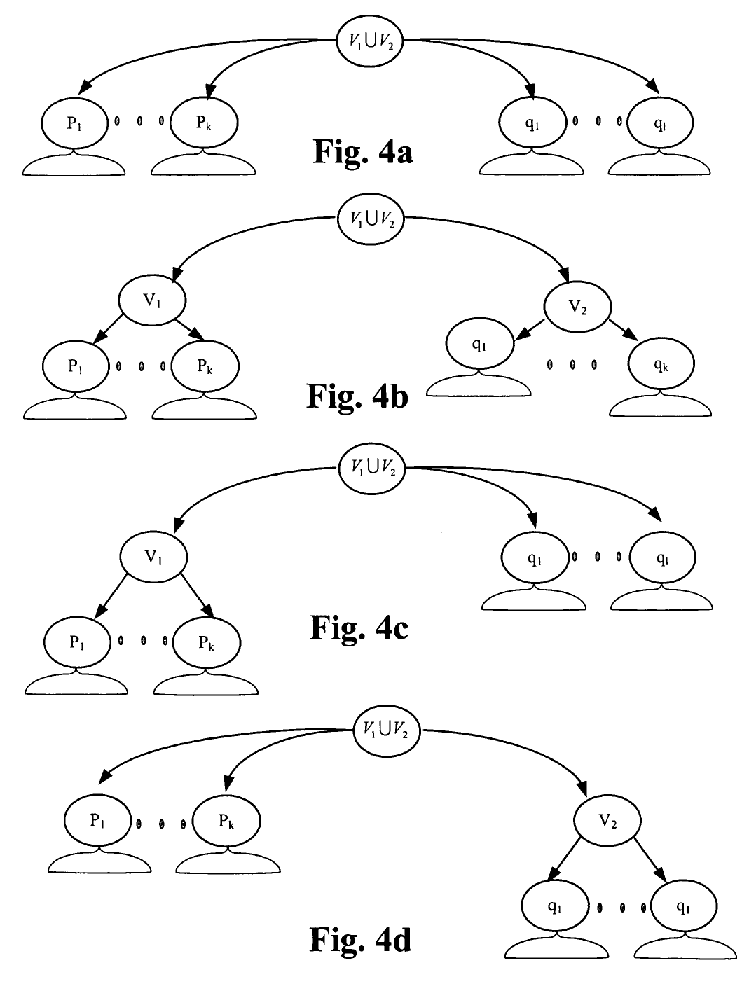

FIGS. 3 and 4a-4d provide an exemplary illustration for merger of two sub-plans 310, 320 of FIG. 3. The set of new sub-plans introduced by merging 310 and 320 is shown in FIGS. 4 (a)-(d). The merging operator of SubPlanMerge(310, 320) returns a set of sub-plans as output. As indicated in FIGS. 4a-4d for each case, the root node of the new sub-plan is v₁∪v₂, which is the smallest relation from which both v₁ and v₂ can be computed. For example, if v₁ is (A,B) and v₂ is (A,C), then v₁∪v₂ is (A,B,C).

FIG. 4a creates a sub-plan wherein the children of v₁ and v₂ are computed directly from the parent, thereby avoiding the cost of computing and materializing both v₁ and v₂, (such sub-plan is only generated when neither v₁ nor v₂ is a required node.) On the other hand, FIG. 4b creates a plan where both v, and v₂ are computed and materialized. Such plan can typically be considered whether or not v, and v₂ are required nodes. The sub-plan of FIG. 4a can be efficient, when the size of v₁∪v₂ is not much larger than the size of v₁ or v₂, whereas the sub-plan of FIG. 4b can be efficient when the size of v₁∪v₂ is much larger than the size of v₁ and v₂. The former is more likely when the values of v₁ and v₂ are highly correlated, whereas the latter is more likely when v, and v₂ are independent.

Likewise, sub-plans illustrated by FIGS. 4c and 4d can be beneficial when either one (but not both) of v₁ and v₂ are much smaller than v₁∪v₂. Thus for example, if v₁∪v₂ has only a slightly higher size than v₂, but at the same time significantly higher size than v₁, then the sub-plan of FIG. 4c can be the best plan—because although sub-plans q₁ . . . q₁ will incur a higher cost, (since they are now computed from v₁∪v₂ instead of from v₂), the increased cost may be more than offset by the reduced cost of not computing and materializing v₂. On the other hand, it may be advantageous to compute sub-plans p₁ . . . pₖ from v₁, even after paying the cost of computing and materializing such node.

An exemplary methodology in accordance with the invention for computing a logical plan for a given input set S={s₁, . . . sₙ} on a relation R is described below. The methodology starts with the “naïve” plan where each sᵢ is computed directly from R. The methodology improves upon the solution until it reaches a local minimum, and does not require the Search DAG as input. Instead such methodology constructs logical plans in a bottom-up manner. This allows the subject invention to scale for large input sizes, e.g., for the common case of computing all single column Group By queries over a relation with many columns. The methodology includes the acts of:

1. Let [symbol] represent the naïve plan, e.g., where each sᵢεS is a sub-plan computed directly from relation R.

2. Let C=Cost(S, [symbol] )

3. Do

4. Let MP=Set of all plans obtained by invoking SubPlanMerge on each pair of sub-plans in [symbol] .

5. Let [symbol] be the lowest cost plan in MP, with cost C′.

6. BetterPlanFound=False

7. If C′<C Then

8. [symbol] = [symbol] ; C=C′: BetterPlanFound=True

9. End If

10. While (BetterPlanFound)

11. Return [symbol] .

For example, the methodology described above can be implemented inside the query optimizers for optimizing a GROUPING SETS query. Typically, query optimizers can use algebraic transformations to change a logical query tree to an equivalent logical query tree. In a Volcano/Cascades style optimizer such transformations are applied in a cost based manner. The methodology presented above can be viewed as a method for obtaining equivalent rewritings of the original GROUPING SETS query.

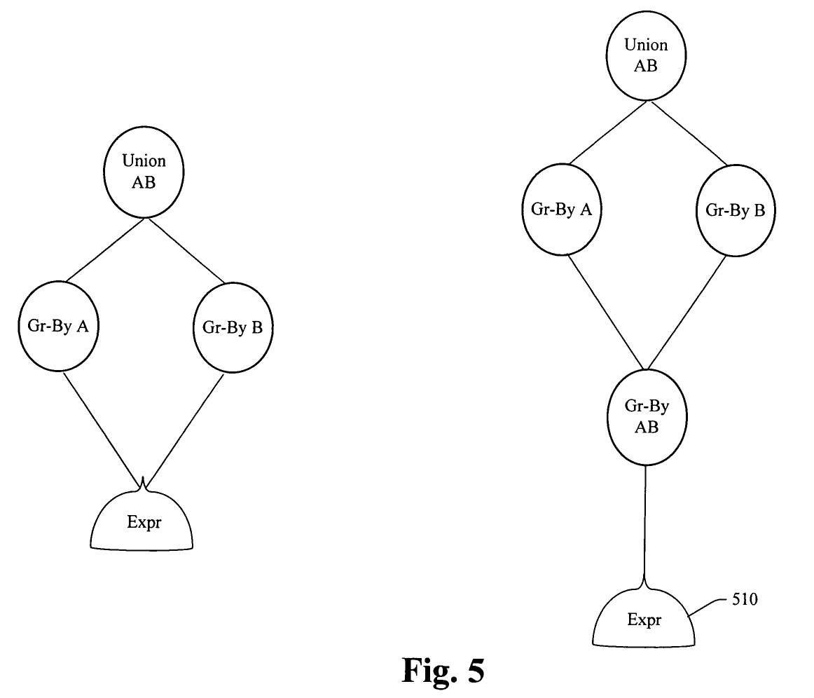

Referring now FIG. 5 two exemplary equivalent logical expressions for computing GROUPING SETS {(A),(B)} are depicted. The sub-tree Expr 510 is the logical expression for the rest of the GROUPING SETS query (e.g., base relation, joins, selections, and the like). An iteration of the greedy algorithm described above can consider different logically equivalent expressions, each of which is equivalent to the input GROUPING SETS query. Furthermore, such expressions can be compared in a cost based manner. In general, costing of plans can be easily implemented in a query optimizer, since such optimizers are already cost based, and merely an ability to estimate the cardinality and average row size of the result of any Group By query is required. Such capability already exists in query optimizers. Moreover, capabilities of estimating statistics over query expressions containing Group-By queries can also facilitate accuracy of cost estimation in this context. Accordingly, in general no new physical operators are required by the subject invention, and the ability to materialize intermediate results is provided by the Spool operator—also available in existing DBMSs.

According to yet another aspect, additional transformation roots can be introduced into an existing query optimizer that is integrated with the subject invention. For example, when a query is more than a simple query, and includes filter predicates, initially a grouping set operation can be performed, followed by applying the filters on top, to obtain a more efficient plan. Moreover, similar to selections, for a reference join a grouping set computation can be pushed below the join, via a transformation rule. The subject invention can provide for different re-writings of the same query and can supply a suitable fit with existing query optimizers.

In general, a GROUPING SETS query can be defined over an arbitrary SQL expression; rather than a single base relation. Two cases of relational operators and their interaction with GROUPING SETS are considered below. One important case is selections, e.g., the query contains a WHERE clause, wherein an approach can be to push the selection below the grouping set, as illustrated as part of the sub-tree 510 of FIG. 5.

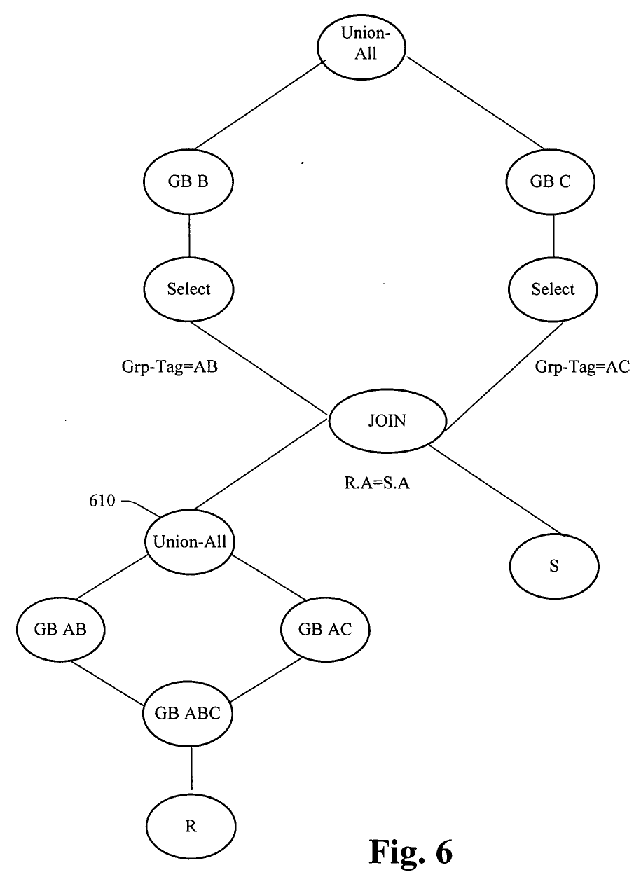

FIG. 6 illustrates a transformation in accordance with an aspect of the subject invention that considers a GROUPING SETS query over the equi-join of two relations R and S (joining column is A), wherein both B and C are columns in R. To compute the GROUPING SETS {(B), (C)}, the transformation shown in FIG. 6 is possible, wherein the Grouping Set computation is “pushed” down below the join of R and S. Similar to the traditional transformation of pushing a Group By below a join, the pushed down Group By queries over R typically needs to include the join attribute in the grouping (to allow subsequent joining with S).

As illustrated in FIG. 6, an optimization technique of the subject invention can be leveraged by introducing the Group By (A,B,C) on R. The Union All node 610 below the Join returns a single result set of all Group Bys below it. Thus, a requirement exist that the Group Bys above the Join obtain only the respective relevant rows. Such can be performed by introducing the notion of a Grp-Tag (e.g., a new column) with each tuple that denotes which Group By query it is a result of. Such tag can be employed to filter out the irrelevant rows.

In a further aspect of the subject invention, an amount of storage for an intermediate table can be reduced by executing a selected plan in a particular order. Accordingly, for each node a determination can be made as to whether breadth-first (BF) or a depth-first (DF) traversal is preferable. For example, given a logical plan (e.g., an output of the methodology of the subject invention), the application can execute the plan as follows. First consider any edge u->v in the logical plan. Next assume that the name of the table corresponding to a node x is Tₓ (if x is the root of the logical plan, then the table is R). If the node v is an intermediate node (and therefore needs to be materialized), generate a query: SELECT v, COUNT(*) AS cnt INTO Tᵥ FROM Tᵤ GROUP BY v. If v is a leaf node, then generate the query: SELECT v, COUNT(*) AS cnt FROM Tᵤ GROUP BY v. It is to be appreciated that if Tᵤ is an intermediate node (and not R), then COUNT(*) should be replaced with SUM(cnt).

Each node in the logical plan corresponds to a SQL Group By query, and for an intermediate node, the results of the query need to be materialized into a temporary table. As explained earlier, when executing a given logical plan: minimizing the storage consumed at any point during execution can be facilitated by the intermediate nodes. It is to be appreciated that although the examples provided herein discuss such issue in the context of client side implementation, similar issues can arise in server as part of a GROUPING SETS query.

Typically, the SQL statements corresponding to a given execution plan tree [symbol] can be generated using either a breadth first or depth first traversal of the tree. When all children of a node u have been computed from it, then the intermediate table corresponding to u can be eliminated, thereby reducing the required storage. However, the manner in which the execution plan tree is traversed for generating the SQL can affect the required storage for intermediate nodes.

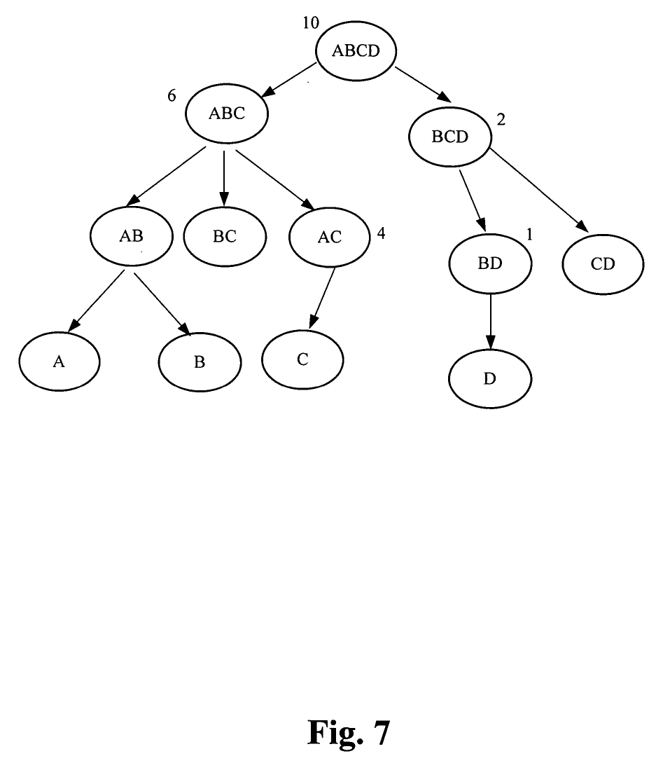

FIG. 7 illustrates an exemplary execution order in accordance with the subject invention. Considering node (ABCD), and if a depth-first traversal strategy is employed, execution of the entire sub-tree rooted at (ABC) followed by the entire sub-tree rooted at (BCD) is required prior to eliminating the temporary table (ABCD). Thus the maximum storage consumed using this strategy is 20 (10+6+4), which corresponds to the storage for simultaneously materializing (ABCD), (ABC) and (AB). Alternatively, if a breadth-first strategy is employed, the maximum storage is 18 (10+6+2), which corresponds to the storage for (ABCD), (ABC) and (BCD). Thus, in this example, a breadth-first traversal results in lower maximum required storage.

Likewise, in other cases, a depth-first traversal may be preferable. Thus, for each node, one of such strategies can prove more advantageous, depending only on the storage requirements on nodes in the subtree. In accordance with an aspect of the subject invention the minimum storage for the sub-tree rooted at u can be written using the following recursive formula:

$$Storage ( u ) = min \{ \begin{matrix} d ( u ) + {\sum }_{i = 1}^{k} d ( {v}_{i} ) \\ d ( u ) + {max}_{i = 1 … k} Storage ( {v}_{i} )\end{matrix} \}$$

wherein u represents any node, d(u) denotes the storage required for materializing node u, Storage(u) denote the minimum storage required for the intermediate nodes (among all possible ways in which the tree can be executed) for the sub-tree rooted at u, and v₁, . . . vₖ represent the children of node u.

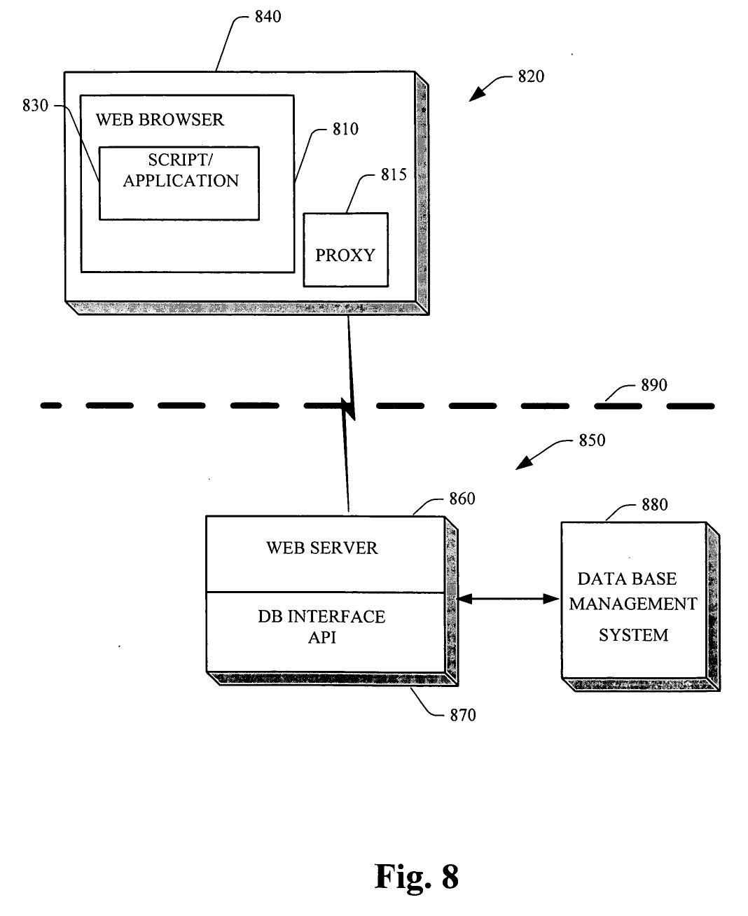

FIG. 8 illustrates a client-server that can implement various aspects of the invention, wherein running on the client 820 is a client process, for example, a web browser 810. Likewise, running on the server 850 is a corresponding server process, for example, a web server 860. In addition, embedded in the Web Browser 810 can be a script or application 830, and running within the run-time environment 840 of the client computer 820, can exist a proxy 815 for packaging and unpacking data packets formatted in accordance with various aspects of the subject invention. Communicating with the server 850 is a database management system (DBMS) 880, which manages access to a database (not shown). The DBMS 880 and the database (not shown) can be located in the server itself, or can be located remotely on a remote database server (not shown). Running on the Web server 860 is a database interface Applications Programming Interface (API) 870, which provides access to the DBMS 880. The client computer 820 and the server computer 850 can communicate with each other through a network 890. When the client process, e.g., the Web browser 810, requests data from a database, the script or application 830 issues a query, which is sent across the network (e.g. internet) 890 to the server computer 850, where it is interpreted by the server process, e.g., the Web server 860. The client's 820 request to server 850 can contain multiple commands, and a response from server 850 can return a plurality of result sets. Responses to client commands that are returned over the network 890 can be self-describing, and record oriented; (e.g. the data streams can describe names, types and optional descriptions of rows being returned.)

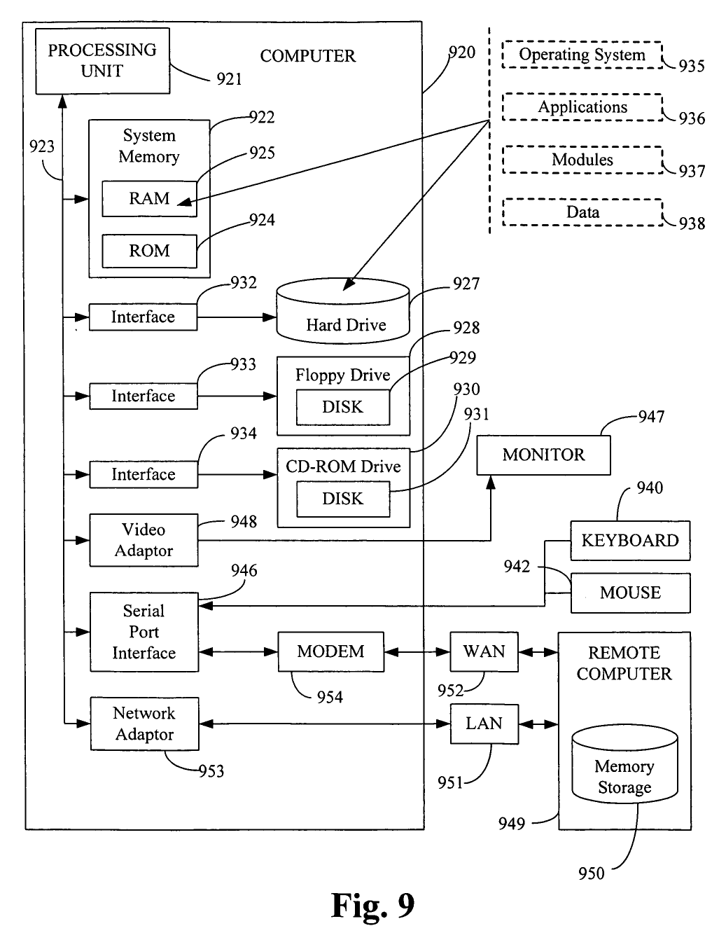

Referring now to FIG. 9, a brief, general description of a suitable computing environment is illustrated wherein the various aspects of the subject invention can be implemented. While the invention has been described above in the general context of computer-executable instructions of a computer program that runs on a computer and/or computers, those skilled in the art will recognize that the invention can also be implemented in combination with other program modules. Generally, program modules include routines, programs, components, data structures, etc. that perform particular tasks and/or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like. As explained earlier, the illustrated aspects of the invention can also be practiced in distributed computing environments where tasks are performed by remote processing devices that are linked through a communications network. However, some, if not all aspects of the invention can be practiced on stand-alone computers. In a distributed computing environment, program modules can be located in both local and remote memory storage devices. The exemplary environment includes a computer 920, including a processing unit 921, a system memory 922, and a system bus 923 that couples various system components including the system memory to the processing unit 921. The processing unit 921 can be any of various commercially available processors. Dual microprocessors and other multi-processor architectures also can be used as the processing unit 921.

The system bus can be any of several types of bus structure including a USB, 1394, a peripheral bus, and a local bus using any of a variety of commercially available bus architectures. The system memory may include read only memory (ROM) 924 and random access memory (RAM) 925. A basic input/output system (BIOS), containing the basic routines that help to transfer information between elements within the computer 920, such as during start-up, is stored in ROM 924.

The computer 920 further includes a hard disk drive 927, a magnetic disk drive 928, e.g., to read from or write to a removable disk 927, and an optical disk drive 930, e.g., for reading from or writing to a CD-ROM disk 931 or to read from or write to other optical media. The hard disk drive 927, magnetic disk drive 928, and optical disk drive 930 are connected to the system bus 923 by a hard disk drive interface 932, a magnetic disk drive interface 933, and an optical drive interface 934, respectively. The drives and their associated computer-readable media provide nonvolatile storage of data, data structures, computer-executable instructions, etc. for the computer 920. Although the description of computer-readable media above refers to a hard disk, a removable magnetic disk and a CD, it should be appreciated by those skilled in the art that other types of media which are readable by a computer, such as magnetic cassettes, flash memory cards, digital video disks, Bernoulli cartridges, and the like, can also be used in the exemplary operating environment, and further that any such media may contain computer-executable instructions for performing the methods of the subject invention. A number of program modules can be stored in the drives and RAM 925, including an operating system 935, one or more application programs 936, other program modules 937, and program data 938. The operating system 935 in the illustrated computer can be substantially any commercially available operating system.

A user can enter commands and information into the computer 920 through a keyboard 940 and a pointing device, such as a mouse 942. Other input devices (not shown) can include a microphone, a joystick, a game pad, a satellite dish, a scanner, or the like. These and other input devices are often connected to the processing unit 921 through a serial port interface 946 that is coupled to the system bus, but may be connected by other interfaces, such as a parallel port, a game port or a universal serial bus (USB). A monitor 947 or other type of display device is also connected to the system bus 923 via an interface, such as a video adapter 948. In addition to the monitor, computers typically include other peripheral output devices (not shown), such as speakers and printers.

The computer 920 can operate in a networked environment using logical connections to one or more remote computers, such as a remote computer 949. The remote computer 949 may be a workstation, a server computer, a router, a peer device or other common network node, and typically includes many or all of the elements described relative to the computer 920, although only a memory storage device 950 is illustrated in FIG. 9. The logical connections depicted in FIG. 9 may include a local area network (LAN) 951 and a wide area network (WAN) 952. Such networking environments are commonplace in offices, enterprise-wide computer networks, Intranets and the Internet.

When employed in a LAN networking environment, the computer 920 can be connected to the local network 951 through a network interface or adapter 953. When utilized in a WAN networking environment, the computer 920 generally can include a modem 954, and/or is connected to a communications server on the LAN, and/or has other means for establishing communications over the wide area network 952, such as the Internet. The modem 954, which can be internal or external, can be connected to the system bus 923 via the serial port interface 946. In a networked environment, program modules depicted relative to the computer 920, or portions thereof, can be stored in the remote memory storage device. It will be appreciated that the network connections shown are exemplary and other means of establishing a communications link between the computers can be employed.

In accordance with the practices of persons skilled in the art of computer programming, the subject invention has been described with reference to acts and symbolic representations of operations that are performed by a computer, such as the computer 920, unless otherwise indicated. Such acts and operations are sometimes referred to as being computer-executed. It will be appreciated that the acts and symbolically represented operations include the manipulation by the processing unit 921 of electrical signals representing data bits which causes a resulting transformation or reduction of the electrical signal representation, and the maintenance of data bits at memory locations in the memory system (including the system memory 922, hard drive 927, floppy disks 928, and CD-ROM 931) to thereby reconfigure or otherwise alter the computer system's operation, as well as other processing of signals. The memory locations wherein such data bits are maintained are physical locations that have particular electrical, magnetic, or optical properties corresponding to the data bits.

Although the invention has been shown and described with respect to certain illustrated aspects, it will be appreciated that equivalent alterations and modifications will occur to others skilled in the art upon the reading and understanding of this specification and the annexed drawings. In particular regard to the various functions performed by the above described components (assemblies, devices, circuits, systems, etc.), the terms (including a reference to a “means”) used to describe such components are intended to correspond, unless otherwise indicated, to any component which performs the specified function of the described component (e.g., that is functionally equivalent), even though not structurally equivalent to the disclosed structure, which performs the function in the herein illustrated exemplary aspects of the invention. In this regard, it will also be recognized that the invention includes a system as well as a computer-readable medium having computer-executable instructions for performing the acts and/or events of the various methods of the invention. Furthermore, to the extent that the terms “includes”, “including”, “has”, “having”, and variants thereof are used in either the detailed description or the claims, these terms are intended to be inclusive in a manner similar to the term “comprising.”

What is claimed is:

1. A system that facilitates computations for a grouping sets query comprising:
an optimizer that receives as input a logical plan for a grouping sets query, and produces an equivalent logical plan; and
a merging component as part of the optimizer that takes as input a pair of sub plans, each sub plan with a root node that directly points to a relation, the merging component returns a set of sub plans having a root node that is a union of root nodes of the pair.

2. The system of claim 1, the optimizer further comprises a cost comparator that compares costs for logical plans associated with grouping sets query.

3. The system of claim 2, the cost comparator with a Cardinality cost model.

4. The system of claim 2, the cost comparator based on a query optimizer of an associated data base management system.

5. The system of claim 4 further comprising a plurality of dummy tables and associated statistics created for nodes that are not materialized.

6. The system of claim 4 further comprising a plurality of additional sets of group by nodes that are not specified in the original logical plan for the grouping sets query.

7. A method of computing a grouping sets query comprising:
initiating a logical plan for a given grouping set query associated with a relation, on a naïve plan that each sub plan is computed directly from the relation;
specifying a cost for execution of the logical plan; and
pairing available sub plans for a merger thereof, to create a new logical plan.

8. The method of claim 7 further comprising maintaining a logical plan with a lowest cost and discarding other logical plans, for each iteration.

9. The method of claim 7 further comprising generating an equivalent logical plan for a grouping set query by exploring possible sub plans in a bottom up manner, without initially materializing an entire lattice associated therewith.

10. The method of claim 7, the specifying the cost act is based on a cost model of an associated query optimizer.

11. The method of claim 10 further comprising introducing an additional set of group by nodes that are not specified in the logical plan for the grouping sets query.

12. The method of claim 10 further comprising supplying a root node that has a smallest relation, from which nodes of the pair can be computed.

13. The method of claim 11 further comprising constructing logical plans in a bottom up manner.

14. The method of claim 7 further comprising a transformation rule that pushes down a grouping set query below a join.

15. The method of claim 7 further comprising reducing an amount of storage for intermediate tables by executing a selected plan in a particular order.

16. The method of claim 15 further comprising executing the selected plan in a breadth first traversal.

17. The method of claim 15 further comprising executing the selected plan in a depth first traversal.

18. The method of claim 7 further comprising defining a minimum storage for a sub-tree rooted at a node as
$$Storage ( u ) = min \{ \begin{matrix} d ( u ) + {\sum }_{i = 1}^{k} d ( {v}_{i} ) \\ d ( u ) + {max}_{i = 1 … k} Storage ( {v}_{i} )\end{matrix} \}$$
where u represents any node, d(u) denotes storage required for materializing node u, Storage(u) denotes minimum storage required for intermediate nodes of the sub-tree rooted at u, and v₁, . . . vₖ represent the children of node u.

19. A system that facilitates grouping sets queries comprising:
means for producing an equivalent logical plan for a grouping sets query; and
means for merging a pair of sub plans to return a set of sub plans with a root node that is a union of roots for the pair.

20. The system of claim 19 further comprising means for comparing costs associated with logical plans for a grouping sets queries.
